(19) United States
(12) Patent Application Publication
(10) Pub. No.: US 2026/0302842 A1
(43) Pub. Date: Oct. 1, 2026

(54) ROTARY ELECTRICAL MACHINE AND MANUFACTURING METHOD THEREFOR

(71) Applicant: HONDA MOTOR CO., LTD., Tokyo (JP)

(72) Inventors: Kazuki MATSUURA, Wako-shi (JP); Kai TSUNEKAWA, Wako-shi (JP); Yoshiyuki NAKAZAWA, Wako-shi (JP); Naoyoshi UMEDA, Wako-shi (JP)

(21) Appl. No.: 19/573,352

(22) Filed: Mar. 20, 2026

(30) Foreign Application Priority Data
Mar. 28, 2025 (JP) 2025-056199

(51) Int. Cl. H02K 1/04; H02K 15/02; H02K 15/10

(52) U.S. Cl. CPC H02K 1/04; H02K 15/02; H02K 15/10; H02K 2213/03; H02K 2215/00

(57) ABSTRACT

A rotary electrical machine includes a stator core and/or a rotor core including steel sheets laminated on each other. Each steel sheet has an insulation coating made of a zirconium chemical conversion coating on a surface thereof. The insulated coating has an amount of zirconium deposited per unit area which is 250 mg/m² or more in terms of metallic zirconium.

### CROSS REFERENCE TO RELATED APPLICATION

The entire disclosure of Japanese Patent Application No. 2025-056199, filed on Mar. 28, 2025, is incorporated herein by reference in its entirety.

### BACKGROUND

The present disclosure relates to a rotary electrical machine and a manufacturing method therefor.

In recent years, research and development have been conducted on electric vehicles that run on the rotational power of rotary electrical machines. The research and development have been and are being conducted in response to growing efforts to realize a low-carbon or carbon-free society, with the aim of reducing CO₂ emissions and improving energy efficiency in vehicles.

In the prior art, there has been known a rotary electrical machine having a motor core in which steel sheets each having an insulation coating formed on its surface are laminated. For example, see Patent Literature 1 (JP7560795B).

In such a rotary electrical machine, a loss caused by eddy currents is reduced by increasing the interlaminar resistance between the laminated steel sheets.

### SUMMARY

However, in the rotary electrical machine in the prior art (for example, see Patent Literature 1), if the insulation coatings are made thicker to further reduce the loss caused by eddy currents, the space factor of the steel sheets in the motor core decreases. In other words, in the rotary electrical machine in the prior art, an improvement in the insulation properties between the steel sheets and an increase in the space factor of the steel sheets in the motor core have a trade-off relationship.

The present disclosure provides a rotary electrical machine and a manufacturing method therefor that can achieve both of the improved insulation properties between steel sheets and the increased space factor of the steel sheets in the motor core.

A rotary electrical machine of the present disclosure includes a stator core and/or a rotor core laminated on each other. Each steel sheet has an insulation coating made of a zirconium chemical conversion coating on a surface thereof. The insulation coating has an amount of zirconium deposited per unit area which is 250 mg/m² or more in terms of metallic zirconium.

A method for manufacturing a rotary electrical machine of the present disclosure includes the steps of: preparing a steel sheet; and forming an insulation coating made of a zirconium chemical conversion coating on a surface of the steel sheet by immersing the steel sheet in a zirconium chemical conversion treatment solution for a predetermined time. The predetermined time is a time sufficient for an amount of zirconium deposited per unit area in the insulation coating to be 250 mg/m² or more in terms of metallic zirconium.

According to the present disclosure, a rotary electrical machine and a manufacturing method therefor can achieve both of the improved insulation properties between steel sheets and the increased space factor of the steel sheets in a motor core.

### BRIEF DESCRIPTION OF THE ACCOMPANYING DRAWINGS

FIG. 1 is an explanatory diagram of a construction of a rotary electrical machine according to an embodiment of the present disclosure.

FIG. 2 is a cross-sectional view of an electromagnetic steel sheet that constitutes a motor core of the rotary electrical machine according to the embodiment of the present disclosure.

FIG. 3 is a manufacturing process diagram of the electromagnetic steel sheet in FIG. 2.

FIG. 4A is an electron micrograph of a cross section of an electromagnetic steel sheet for a motor core obtained in a manufacturing method in an example of the present disclosure.

FIG. 4B is an electron micrograph of a surface of the electromagnetic steel sheet for the motor core obtained in the manufacturing method in the example of the present disclosure.

FIG. 5A is an electron micrograph of a cross section of an electromagnetic steel sheet for a motor core obtained in a manufacturing method in a comparative example of the present disclosure.

FIG. 5B is an electron micrograph of a surface of the electromagnetic steel sheet for the motor core obtained in the manufacturing method in the comparative example of the present disclosure.

### DESCRIPTION OF THE EMBODIMENTS

Hereinafter, a mode (embodiment) for carrying out a rotary electrical machine and a manufacturing method thereof of the present disclosure will be described in detail with reference to the drawings as needed.

A rotary electrical machine according to the present embodiment is intended to be mounted on a hybrid vehicle or an electric vehicle and used as an electric motor for driving the vehicle, but may also be used for a variety of other purposes.

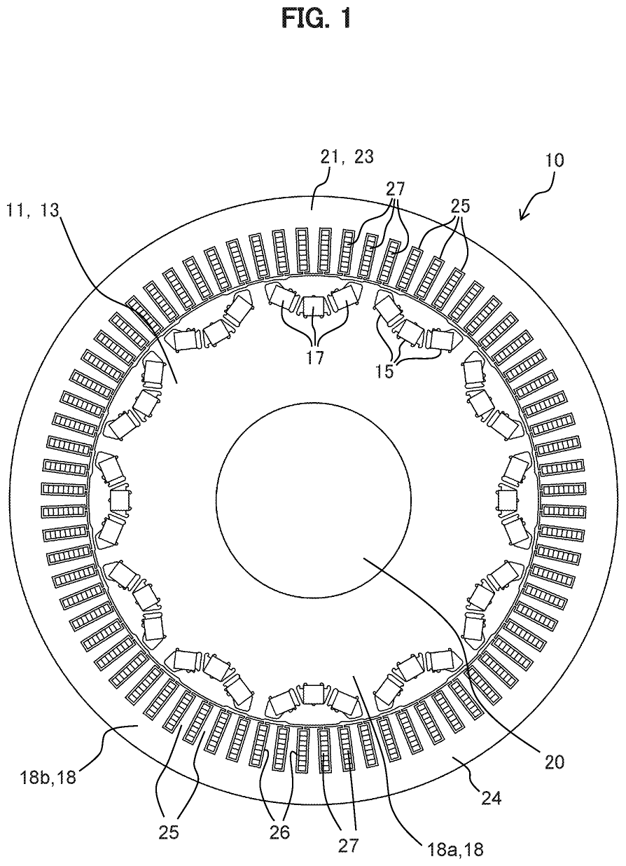

FIG. 1 is an explanatory diagram of a structure of a rotary electrical machine 10 according to the present embodiment and is a cross-sectional view of the rotary electrical machine 10 perpendicular to the axis of the rotary electrical machine 10.

As shown in FIG. 1, the rotary electrical machine 10 includes a cylindrical rotor 11 and an annular stator 21.

The rotor 11 is disposed on an inner circumferential side of the stator 21 so as to be coaxial with the stator 21. Thus, the outer circumferential surface of the rotor 11 is located with a small gap from the inner circumferential surface of the stator 21. The rotor 11 is capable of rotating on the inner circumferential side of the stator 21 about a rotor shaft 20 formed integrally with the rotor 11.

Permanent magnets 17 made of neodymium magnets or the like are disposed in a rotor core 13 (motor core) constituting the rotor 11. The multiple permanent magnets 17 are disposed on the outer circumferential side of the rotor core 13 in the circumferential direction. Each permanent magnet 17 is a rod-shaped body having a rectangular cross section and extends in the axial direction of the rotor core 13 (the direction perpendicular to the paper surface of FIG. 1).

Specifically, sets each formed by three permanent magnets 17 are disposed at equal intervals in the circumferential direction.

The three permanent magnets 17 forming each set, specifically, the permanent magnet 17 located at the center in the circumferential direction and a pair of permanent magnets 17 disposed on both sides of the above central permanent magnet 17 in the circumferential direction in the cross-sectional view shown in FIG. 1 form an approximate V shape opened outward in a radial direction. In other words, among the three permanent magnets 17, the pair of permanent magnets 17 are disposed close to the outer circumferential surface of the rotor core 13, whereas the central permanent magnet 17 is displaced from the pair of permanent magnets 17 inward in the radial direction.

The three permanent magnets 17 forming each set are attached to the rotor core 13 by being inserted into magnet housing holes 15 formed in the rotor core 13 at positions corresponding to the positions of the respective permanent magnets 17. Each of the three permanent magnets 17 is inserted into the corresponding one of three magnet housing holes 15 penetrating through the rotor core 13 in the axial direction.

The rotor core 13 as described above is formed in such a way that multiple electromagnetic steel sheets 18a (steel sheets) each having a planar shape corresponding to the planar shape of the rotor core 13 are laminated in the axial direction of the rotary electrical machine 10.

A stator core 23 (motor core) constituting the stator 21 includes an annular yoke 24 as shown in FIG. 1. The stator core 23 includes multiple teeth 25 each extending from the yoke 24 toward the inner circumferential side on which the axis of the stator 21 is located. The stator core 23 has slots 26 as a space formed between neighboring two of the teeth 25. Each slot 26 is formed to extend from the inner circumferential side of the stator core 23 outward in the radial direction.

In the slots 26, coils 27 wound around the teeth 25 are disposed.

In the present embodiment, the coils 27 include three phase coils: U-phase coils, V-phase coils, and W-phase coils. Although not shown in the drawings, the U-phase coils, the V-phase coils, and the W-phase coils are electrically coupled to a power conversion apparatus via U-phase lead wires, V-phase lead wires, and W-phase lead wires, respectively. The power conversion apparatus in the present embodiment is assumed to be a power drive unit (PDU). The PDU converts DC power from a battery, which is a power source of a vehicle, into three-phase AC power, and also converts three-phase AC power regenerated by the rotary electrical machine 10 into DC power.

In a case where the rotary electrical machine 10 is used as an electric motor, the three-phase coils are supplied with corresponding three-phase AC power from the power conversion apparatus (not shown). Thus, a magnetic field is generated in the stator 21 and this magnetic field interacts with a magnetic field generated by the permanent magnets 17 of the rotor 11. As a result, the rotor 11 rotates. Alternatively, in a case where the rotary electrical machine 10 is used as a power generator, three-phase AC power generated with rotations of the rotor 11 is supplied to the power conversion apparatus (not shown). The power conversion apparatus converts the three-phase AC power into DC power and stores the DC power in the battery.

The stator core 23 as described above is formed in such a way that multiple electromagnetic steel sheets 18b (steel sheets) each having a planar shape corresponding to the planar shape of the stator core 23 are laminated in the axial direction of the rotary electrical machine 10.

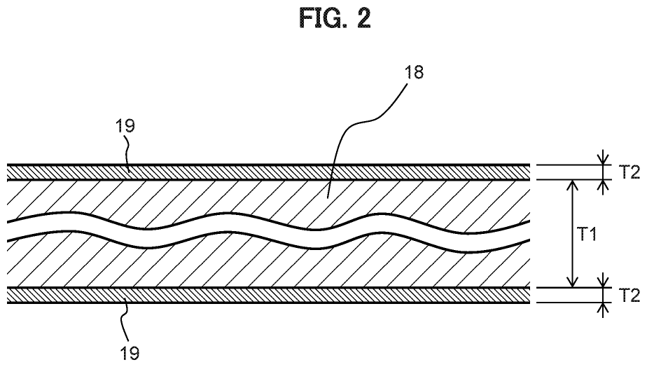

The rotary electrical machine 10 (see FIG. 1) in the present embodiment includes insulation coatings 19 (see FIG. 2), which will be described later, on the surfaces of the electromagnetic steel sheets 18a and/or the electromagnetic steel sheets 18b. Specifically, the rotary electrical machine 10 includes the insulation coatings 19 (see FIG. 2), which will be described later, on the surfaces of at least the electromagnetic steel sheets 18a of the rotor core 13 or the electromagnetic steel sheets 18b of the stator core 23.

Next, the electromagnetic steel sheets 18a (see FIG. 1) and the electromagnetic steel sheets 18b (see FIG. 1) will be described specifically.

The electromagnetic steel sheets 18a and the electromagnetic steel sheets 18b in the present embodiment are different from each other only in planar shape. Therefore, the electromagnetic steel sheets 18a and 18b will be simply referred to as the electromagnetic steel sheet 18 if there is no need to distinguish between the electromagnetic steel sheets 18a and 18b.

FIG. 2 is a cross-sectional view of the electromagnetic steel sheet 18 constituting the rotary electrical machine 10 (see FIG. 1).

As shown in FIG. 2, the electromagnetic steel sheet 18 includes an insulation coating 19 on its surface.

For the electromagnetic steel sheet 18 in the present embodiment, a magnetic thin strip made of a soft magnetic material is used.

As the soft magnetic material, for example, an alloy containing iron, silicon, boron, and the like as main components or an alloy in which phosphorus, copper, and the like are added to the foregoing alloy is used.

The magnetic thin strip is formed in such a way that a homogenized molten metal of a soft magnetic material with a predetermined composition is spread on a metal plate or a metal roll and formed into a foil strip shape by rapid cooling casting.

Such a magnetic thin strip is formed of an amorphous soft magnetic material (amorphous alloy). The soft magnetic material may also be microcrystallized by heat treatment, thereby being formed into a nanocrystalline soft magnetic material with magnetic domain walls controlled.

A thickness T of the electromagnetic steel sheet 18 in the present embodiment is, for example, 30 μm or more and 100 μm or less.

In the present embodiment, the insulation coating 19 may mainly contain a zirconium dioxide dihydrate (ZrO₂.2H₂O).

This insulation coating 19 is formed of a zirconium chemical conversion coating as will be described later.

The insulation coating 19 may contain an amorphous zirconium hydroxide (Zr(OH)₄) in addition to the zirconium dioxide dihydrate.

A thickness T2 of the insulation coating 19 (zirconium chemical conversion coating) is, for example, 3 nm or more and 400 nm or less.

The zirconium content (amount of zirconium deposited) in the insulation coating 19 (zirconium chemical conversion coating) is, for example, 250 mg/m² or more in terms of metallic zirconium per unit area in the insulation coating 19.

Next, a method for manufacturing the rotary electrical machine 10 (see FIG. 1) will be described.

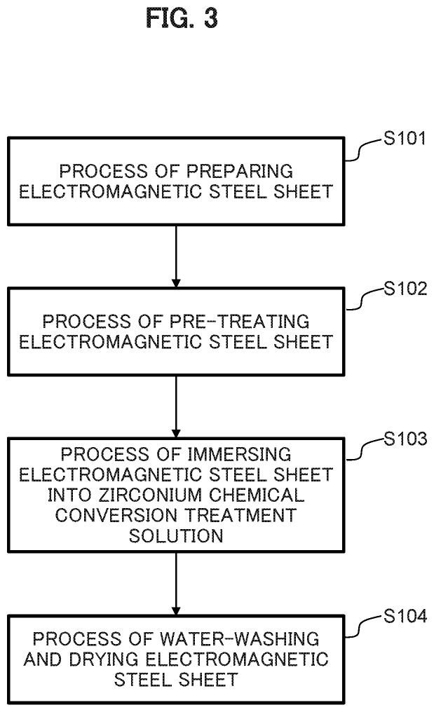

FIG. 3 is a manufacturing process diagram of the rotary electrical machine 10 (see FIG. 1), and is the manufacturing process diagram of the electromagnetic steel sheet 18 (see FIG. 2) having the insulation coating 19 in particular in the rotary electrical machine 10. In the following description, the reference sign of the electromagnetic steel sheet 18 will be omitted.

As shown in FIG. 3, the manufacturing method in the present embodiment includes a process of preparing an electromagnetic steel sheet (step S101), a process of pre-treating the electromagnetic steel sheet (step S102), a process of immersing the electromagnetic steel sheet into a zirconium chemical conversion treatment solution (step S103), and a process of water-washing and drying the electromagnetic steel sheet (S104).

In the preparation process in step S101, the electromagnetic steel sheet is supplied as a roll with a predetermined width.

In the pre-treatment process in step S102, the electromagnetic steel sheet unwound from the roll is subjected to a degreasing treatment, a water wash after the degreasing treatment, a pickling treatment, and a water wash after the pickling treatment.

The degreasing treatment removes oil and other foreign substances adhering to the electromagnetic steel sheet. The degreasing treatment in the present embodiment is assumed to be performed by using a surfactant, but the degreasing treatment is not limited to this. Any known degreasing treatment such as alkali degreasing may be performed.

The pickling treatment removes an oxidized film and a hydroxide film formed on the surface of the electromagnetic steel sheet. The pickling treatment in the present embodiment is, for example, a known pickling treatment using hydrochloric acid, sulfuric acid, nitric acid, or the like, but the pickling treatment is not limited to these. The pickling treatment may be also performed by electrolytic pickling.

In the immersion process in step S103, the electromagnetic steel sheet is immersed in a bath filled with a zirconium chemical conversion treatment solution for a predetermined time.

In this immersion process, a chemical reaction between the iron contained in the electromagnetic steel sheet and the zirconium chemical conversion treatment solution forms a coating containing zirconium dioxide (zirconium chemical conversion coating) on the surface of the electromagnetic steel sheet. Specifically, in this process, the chemical reaction between the zirconium chemical conversion treatment solution and the iron contained in the electromagnetic steel sheet changes a chemical equilibrium of the components contained in the zirconium chemical conversion treatment solution, thereby promoting deposition of zirconium-containing components on the surface of the electromagnetic steel sheet.

The zirconium chemical conversion treatment solution is, for example, an aqueous solution containing hydrofluoric acid (HF) and hexafluorozirconate (H₂ZrF₆), but is not limited to this. As the zirconium chemical conversion treatment solution, a commercially available product to be described later may be used.

An immersion time for which the electromagnetic steel sheet is immersed in the zirconium chemical conversion treatment solution is set to a time sufficient for the amount of zirconium deposited in the coating to be 250 mg/m² or more in terms of metallic zirconium. Specifically, the immersion time is, for example, 30 minutes or more.

Through the immersion process as described above, a zirconium chemical conversion coating with a thickness T2 (see FIG. 2) of about 3 nm to 400 nm is formed on the surface of the electromagnetic steel sheet.

In the water-washing and drying process in step S104, the electromagnetic steel sheet having undergone the immersion process in step S103 is sprayed and washed with deionized water or the like, and then dried by hot air at about 80° C.

Then, in this manufacturing method, the electromagnetic steel sheet having the zirconium chemical conversion coating on its surface is punched out into a planar shape corresponding to the planar shape of the stator core. The same electromagnetic steel sheet is punched out into a planar shape corresponding to the planar shape of the rotor core. Multiple electromagnetic steel sheets thus punched out are laminated to form the stator core 23 (see FIG. 1) or the rotor core 13 (see FIG. 1). As shown in FIG. 1, the aforementioned rotary electrical machine (see FIG. 1) is completed with the rotor core 13 disposed on the inner circumferential side of the stator core 23.

### Effects

Next, effects produced by the rotary electrical machine 10 and the manufacturing method thereof according to the present embodiment will be described.

The rotary electrical machine 10 according to the present embodiment includes the stator core 23 (motor core) and/or the rotor core 13 (motor core) in which the multiple electromagnetic steel sheets 18 each having the insulation coating 19 made of the zirconium chemical conversion coating on its surface are laminated. The amount of zirconium deposited per unit area in the insulation coating 19 is 250 mg/m² or more in terms of metallic zirconium.

In this rotary electrical machine 10, the insulation properties between the neighboring electromagnetic steel sheets 18 are excellent even though the thickness of the insulation coating 19 is at a nanometer level.

Such a rotary electrical machine 10 can achieve both of the improved insulation properties between the electromagnetic steel sheets 18 and the increased space factor of the electromagnetic steel sheets 18 in the motor core.

In this rotary electrical machine 10, the thickness T2 of the insulation coating 19 is, for example, 3 nm or more and 400 nm or less.

Such a rotary electrical machine 10 more surely achieves both of the improved insulation properties between the electromagnetic steel sheets 18 and the increased space factor of the electromagnetic steel sheets 18.

In this rotary electrical machine 10, the thickness T1 of the electromagnetic steel sheet 18 is, for example, 30 μm or more and 100 μm or less.

Such a rotary electrical machine 10 achieves not only the increased space factor of the electromagnetic steel sheets 18, but also both of a high magnetic flux density and a low iron loss in the motor core.

In this rotary electrical machine 10, the zirconium in the zirconium chemical conversion coating may be contained as amorphous zirconium dioxide dihydrate and zirconium hydroxide.

Such a rotary electrical machine 10 more surely achieves the improved insulation properties between the electromagnetic steel sheets 18.

The method for manufacturing the rotary electrical machine 10 includes the process of preparing the electromagnetic steel sheet 18. This manufacturing method includes the process of immersing the electromagnetic steel sheet 18 in the zirconium chemical conversion treatment solution for the predetermined time, thereby forming the insulation coating 19 made of the zirconium chemical conversion coating on the surface of the electromagnetic steel sheet 18. The predetermined time is the time sufficient for the amount of zirconium deposited per unit area in the insulation coating to be 250 mg/m² or more in terms of metallic zirconium.

According to this manufacturing method, the rotary electrical machine 10 is obtained which achieves both of the improved insulation properties between the electromagnetic steel sheets 18 and the increased space factor of the electromagnetic steel sheets 18 in the motor core.

In this manufacturing method, the predetermined time is, for example, 30 minutes or more.

According to this manufacturing method, the rotary electrical machine 10 is more surely obtained which is excellent in the insulation properties between the electromagnetic steel sheets 18.

Hereinabove, the present embodiment is described. However, the present disclosure is not limited to the above embodiment, but may be carried out in various modes.

### EXAMPLE

Next, the present disclosure will be further specifically described by showing an example and a comparative example.

### Example

In the present example, the electromagnetic steel sheet 18 with the insulation coating 19 shown in FIG. 2 was fabricated.

First, a test piece with a predetermined area is cut out from a magnetic thin strip made of a Fe—Si alloy and having a thickness of 100 μm. This test piece was subjected to the degreasing treatment using a surfactant and the pickling treatment.

Next, the test piece was immersed in a 50 g/L aqueous solution of zirconium chemical conversion treatment solution (PALLUCID (registered trademark) 1500, manufactured by Nihon Parkerizing Co., Ltd.) at 45° C. for 30 minutes. After that, this test piece was sprayed and washed with deionized water at room temperature and then dried with hot air in an electric furnace at 80° C. for 5 minutes. The obtained test piece (electromagnetic steel sheet) was observed with an electron microscope.

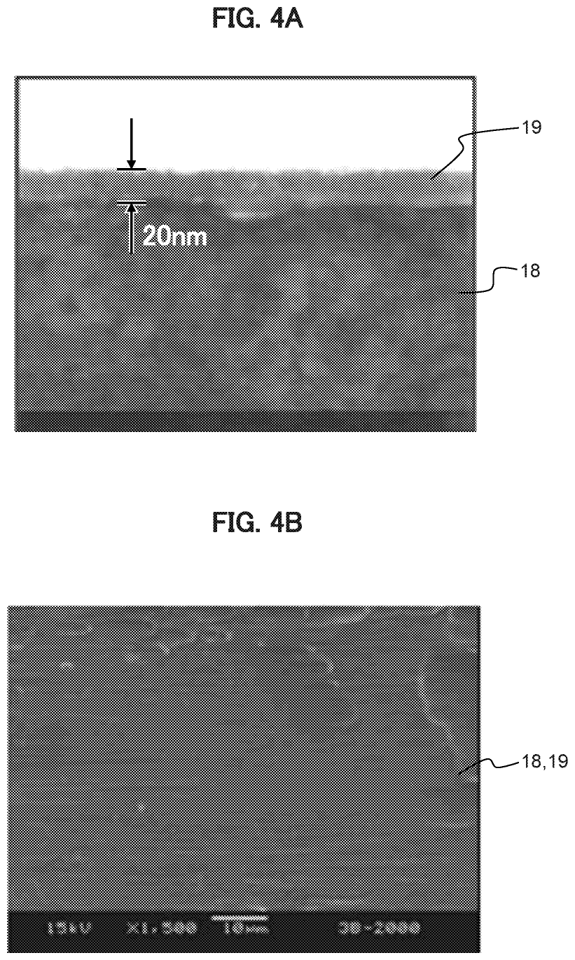

FIG. 4A is a photograph taken with a scanning transmission electron microscope (STEM) of a cross section of the electromagnetic steel sheet 18 with the insulation coating 19 obtained in the present example. FIG. 4B is a photograph taken with a scanning electron microscope (SEM) of a surface of the electromagnetic steel sheet 18 with the insulation coating 19 obtained in the present example.

As shown in FIG. 4A, it was confirmed that the insulation coating 19 made of the zirconium chemical conversion coating and having a thickness of 20 nm was formed on the surface of the electromagnetic steel sheet 18.

As shown in FIG. 4B, it was confirmed that the insulation coating 19 was an amorphous zirconium chemical conversion coating.

The insulation coating 19 insulated more than 90% of the entire surface of the electromagnetic steel sheet 18.

The amount of zirconium deposited per unit area in the insulation coating 19 was 289 mg/m² in terms of metallic zirconium.

The iron loss (W10/400) of the electromagnetic steel sheet 18 at a frequency of 400 Hz and a magnetic flux density of 1.0 T was changed from 6.7 (W/kg) to 6.8 (W/kg) as a result of forming the insulation coating 19. The value of the magnetic flux density (B50) at a magnetic field strength of 5000 (A/m) was substantially maintained at 1.63 T even after the insulation coating 19 was formed. Here, the insulation coating 19 also exhibited good adhesion to thermosetting resins such as epoxy resin.

It was verified that the electromagnetic steel sheet 18 in the present example provided not only an increased space factor owing to the very thin insulation coating 19, but also both of a high magnetic flux density and a low iron loss.

### Comparative Example

In a present comparative example, a test piece (electromagnetic steel sheet 18) with a chemical conversion coating 22 made of zinc phosphate tribasic (Zn(PO₄)₂)) was prepared in the same manner as in the above example, except that a chemical conversion treatment solution containing zinc phosphate monobasic (Zn(H₂PO₄)₂)) as a main component was used instead of the zirconium chemical conversion treatment solution used in the above example.

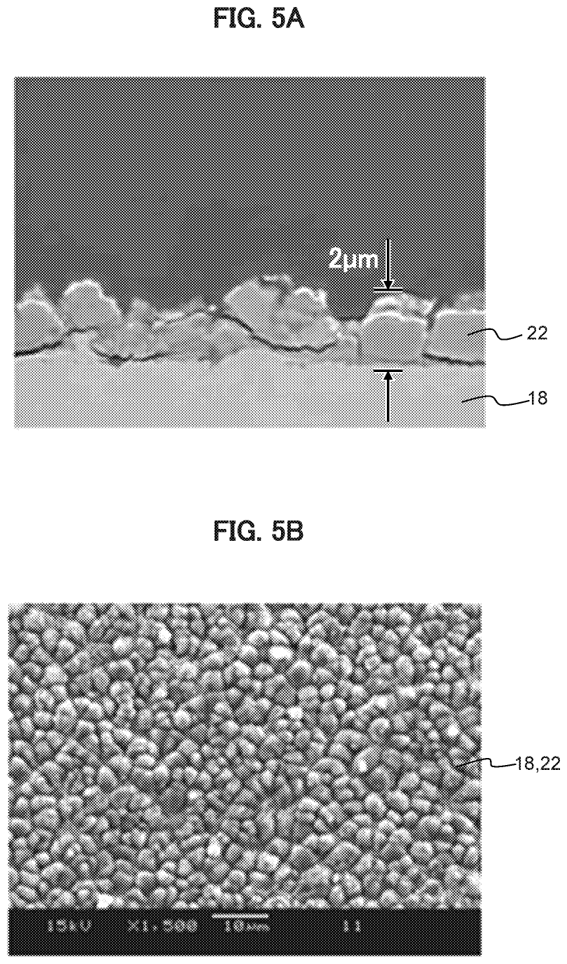

FIG. 5A is a photograph taken with the SEM of a cross section of the electromagnetic steel sheet 18 with the chemical conversion coating 22 obtained in the comparative example. FIG. 5B is a photograph taken with the SEM of a surface of the electromagnetic steel sheet 18 with the chemical conversion coating 22 obtained in the comparative example.

As shown in FIG. 5A, the thickness of the chemical conversion coating 22 in the comparative example was 2 μm, which is greater than the thickness of the insulation coating in the example.

As shown in FIG. 5B, the chemical conversion coating 22 in the comparative example was crystalline.

What is claimed is:

1. A rotary electrical machine comprising a stator core and/or a rotor core which includes steel sheets laminated on each other,
wherein each steel sheet has an insulation coating made of a zirconium chemical conversion coating on a surface thereof, and
wherein the insulation coating has an amount of zirconium deposited per unit area which is 250 mg/m² or more in terms of metallic zirconium.

2. The rotary electrical machine according to claim 1, wherein the insulation coating has a thickness of 3 nm or more and 400 nm or less.

3. The rotary electrical machine according to claim 1, wherein each steel sheet has a thickness of 30 μm or more and 100 μm or less.

4. The rotary electrical machine according to claim 1, wherein zirconium in the zirconium chemical conversion coating is contained as amorphous zirconium dioxide dihydrate.

5. A method for manufacturing a rotary electrical machine, comprising:
preparing a steel sheet; and
forming an insulation coating made of a zirconium chemical conversion coating on a surface of the steel sheet by immersing the steel sheet in a zirconium chemical conversion treatment solution for a predetermined time,
wherein the predetermined time is a time sufficient for an amount of zirconium deposited per unit area in the insulation coating to be 250 mg/m² or more in terms of metallic zirconium.

6. The method for manufacturing a rotary electrical machine according to claim 5, wherein the predetermined time is 30 minutes or more.
